(19) United States
(12) Patent Application Publication
(10) Pub. No.: US 2024/0075858 A1
(43) Pub. Date: Mar. 7, 2024

(54) VEHICLE SEAT

(71) Applicants: NHK SPRING CO., LTD., Yokohama-shi (JP); SUBARU CORPORATION, Tokyo (JP)

(72) Inventors: Keishiro ITO, Yokohama-shi (JP); Takumi ABE, Yokohama-shi (JP); Yosuke ISHIYAMA, Tokyo (JP); Yohei SUGIHIRA, Tokyo (JP); Masato FUKUSHIMA, Tokyo (JP)

(21) Appl. No.: 18/455,423

(22) Filed: Aug. 24, 2023

(30) Foreign Application Priority Data
Aug. 30, 2022 (JP) 2022-136707

(51) Int. Cl. B60N 2/56; B60N 2/66

(52) U.S. Cl. CPC B60N 2/565; B60N 2/5657; B60N 2/66

(57) ABSTRACT

A vehicle seat, comprising: a seat back pad attached to a seat back frame configuring a frame; a back support device provided on a seat rear side of the seat back pad, configured to assist a seated posture of a seated person, and including an opening penetrating in a seat back thickness direction; and an air conditioning device including an air conditioner configured to suction and blow out air, and a flow path forming portion connected to the air conditioner, inserted into the opening of the back support device, and performing at least one of blowing out air to a side of the seated person or suctioning air from the seated person side in accordance with the air conditioner.

### CROSS-REFERENCE TO RELATED APPLICATION

This application is based on and claims priority under 35 USC 119 from Japanese Patent Application No. 2022-136707 filed on Aug. 30, 2022, the disclosure of which is incorporated by reference herein.

### BACKGROUND

### Technical Field

The present disclosure relates to a vehicle seat.

Japanese Patent Application Laid-Open (JP-A) No. 2010-29508 discloses a seat including a seat air-conditioning device capable of blowing air toward the back of a human body seated on the seat. The seat described in JP-A No. 2010-29508 includes a lumbar support that supports a waist of a human body by a plate, and a blowing duct through which air blown toward the back of the human body seated on the seat flows.

Incidentally, in a so-called ventilation seat including an air conditioning device that performs at least one of blowing air to a seated person side and sucking air from the seated person side in a seat back, it is conceivable to form a flow path forming portion forming a flow path through which air flows with a soft material such as a polyurethane film from the viewpoint of mountability of the air conditioning device on a vehicle seat.

In this case, when the flow path forming portion is pressed by a local load at the time of seating, the flow path forming portion may be crushed and the air-conditioning efficiency may be lowered. Therefore, it is desirable that the collapse of the flow path forming portion can be suppressed in the ventilation seat, but the configuration described in JP-A No. 2010-29508 does not consider this point.

### SUMMARY

The present disclosure provides a vehicle seat capable of improving air-conditioning efficiency of an air conditioning device mounted on the seat.

According to a first aspect, there is provided a vehicle seat including: a seat back pad attached to a seat back frame configuring a frame; a back support device provided on a seat rear side of the seat back pad, configured to assist a seated posture of a seated person, and including an opening penetrating in a seat back thickness direction; and an air conditioning device including an air conditioner configured to suction and blow out air, and a flow path forming portion connected to the air conditioner, inserted into the opening of the back support device, and performing at least one of blowing out air to a side of the seated person or suctioning air from the seated person side in accordance with the air conditioner.

According to the vehicle seat of the first aspect, the seat back pad is attached to the seat back frame constituting the frame. The back support device configured to assist the seated posture of the seated person is provided on a rear side of the seat back pad. Therefore, the back of the seated person is supported by the back support device and the seat back pad supported by the back support device from the rear side.

In a case in which the air conditioning device mounted on the vehicle seat blows air toward the seated person, the air is sent from the air conditioner to the vicinity of the back of the seated person via the flow path forming portion. In a case in which the air conditioning device mounted on the vehicle seat sucks air from the side of the seated person, the air is sucked into the air conditioner from around the back of the seated person via the flow path forming portion.

When a substantially backward load is applied to the seat back from the back of the seated person, the seat back pad is restricted from moving toward the seat rear side by the back support device provided on the seat rear side of the seat back pad. Here, the flow path forming portion connected to the air conditioner is inserted into an opening portion penetrating in the seat back thickness direction in the back support device, that is, in the substantially front-rear direction in a standing posture of the seat back. Therefore, it is possible to prevent the flow path forming portion from being sandwiched and crushed between the seat back pad and an end portion in a vertical direction or an end portion in a seat width direction of the back support device. As a result, the flow of the air blown out from the air conditioner and sent to the seated person side through the flow path forming portion or the flow of the air sucked from the seated person side and sent to the air conditioner through the flow path forming portion is prevented from being obstructed.

In a vehicle seat according to a second aspect, in the first aspect, the air conditioner of the air conditioning device is provided above the back support device.

According to the vehicle seat of the second aspect, since the air conditioner is provided on the seat upper side of the back support device, that is, at a position not overlapping with the back support device as viewed in the seat back thickness direction, the dimension of the seat back in the thickness direction can be suppressed.

The flow path forming portion extending from the air conditioner is disposed through a rear side and an upper side of the opening portion of the back support device. Even in a case in which the air conditioner is not disposed immediately behind the opening portion as described above, the back support device restricts movement of the seat back pad toward the seat rear side, so that deformation of the flow path forming portion passing through the rear side of the back support device is suppressed. Therefore, it is possible to prevent the flow path forming portion extending from the air conditioner from being sandwiched between the seat back pad and the upper end portion of the back support device and being crushed.

In a vehicle seat according to a third aspect, in the second aspect, the back support device includes a pressure receiving portion which is configured to be deformable by receiving a load from a back of the seated person and in which the opening is formed at an upper portion, a lumbar support portion configured to support a waist of the seated person via the pressure receiving portion, and an upper frame portion configured to support the upper portion of the pressure receiving portion from the seat rear side at a lower edge portion of the opening portion.

According to the vehicle seat of the third aspect, the waist of the seated person is supported by the lumbar support portion via the pressure receiving portion. The pressure receiving portion is deformed by receiving a load from the back of the seated person. Accordingly, the seated person can maintain a favorable seated posture.

Here, the upper portion of the pressure receiving portion is supported by the upper frame portion. Specifically, the pressure receiving portion is supported from the seat rear side by the upper frame portion at a lower edge portion of the opening portion.

When the opening portion is not formed in the pressure receiving portion, the flow path forming portion is connected to the air conditioner through the upper side of the back support device. In this case, when a backward load is applied to the seat back from the back of the seated person, the flow path forming portion is sandwiched and crushed between the upper end portion of the pressure receiving portion or the upper frame portion and the seat back pad.

Meanwhile, in the vehicle seat according to the third aspect, the opening portion is formed in the upper portion of the pressure receiving portion, and the flow path forming portion is inserted into the opening. Therefore, the upper edge portion of the opening restricts the movement of the seat back pad toward the seat rear side, so that the flow path forming portion is prevented from being sandwiched between the seat back pad and the lower edge portion of the opening portion or the upper frame portion.

In a vehicle seat according to a fourth aspect, in the third aspect, the seat back pad includes an insertion portion penetrating in the seat back thickness direction, and the flow path forming portion includes a duct portion connected to the air conditioner and inserted into the opening of the back support device and the insertion portion of the seat back pad, and a ventilation portion connected to the duct portion and extending along a front surface side of the seat back pad, the ventilation portion performing at least one of the blowing out of air to the seated person side and the suctioning of air from the seated person side in accordance with the air conditioner.

According to the vehicle seat of the fourth aspect, the duct portion in the flow path forming portion is connected to the air conditioner and is inserted into the insertion portion that is inserted into the opening portion of the back support device and penetrates the seat back pad in the seat back thickness direction. That is, the duct portion connected to the air conditioner passes through the opening portion from the rear side of the back support device, further passes through the insertion portion of the seat back pad, and extends to the front surface side of the seat back pad.

The ventilation portion connected to the duct portion extends along the front surface side of the seat back pad, and at least one of the blowing out of air to the seated person side and the sucking of air from the seated person side is performed by the ventilation portion. Therefore, the periphery of the back of the seated person is efficiently ventilated.

In a vehicle seat according to a fifth aspect, in the fourth aspect, the opening of the pressure receiving portion in the back support device is formed at a back side of the insertion portion of the seat back pad as viewed from a seat front surface side in the seat back thickness direction.

According to the vehicle seat of the fifth aspect, since the opening portion of the back support device is formed in the vicinity of the insertion portion of the seat back pad, the duct portion is prevented from being sandwiched and crushed between the pressure receiving portion and the seat back pad in a section between the opening portion of the back support device and the insertion portion of the seat back pad. Since it is not necessary to dispose the duct portion in a long bent complicated path, it is possible to further improve the air-conditioning efficiency while disposing the duct portion with high space efficiency.

The vehicle seat according to the first aspect has an excellent effect of improving the air-conditioning efficiency of an air conditioning device mounted on the seat.

The vehicle seat according to the second aspect has an excellent effect of improving designability while maintaining performance of the back support device and the air conditioning device.

The vehicle seat of the third aspect has an excellent effect of further improving the air-conditioning efficiency of the air conditioning device mounted on the seat.

The vehicle seat of the fourth aspect has an excellent effect of further improving the air-conditioning efficiency of the air conditioning device mounted on the seat.

The vehicle seat of the fifth aspect has an excellent effect that the air-conditioning efficiency of the air conditioning device mounted on the seat can be further improved while the duct portion is disposed with high space efficiency.

### BRIEF DESCRIPTION OF THE DRAWINGS

An exemplary embodiment of the present disclosure will be described in detail based on the following figures, wherein:

FIG. 1 is a front perspective view of a vehicle seat according to the present embodiment;

FIG. 2 is a front view illustrating a seat back pad and an air conditioning device of the seat back illustrated in FIG. 1;

FIG. 3 is a rear view of a back support device illustrated in FIG. 1;

FIG. 4 is a front view of a basket of the back support device illustrated in FIG. 3;

FIG. 5 is a cross-sectional view taken along line 5-5 of the vehicle seat illustrated in FIG. 1;

FIG. 6 is an enlarged view of a main part of FIG. 5; and

FIG. 7 is a diagram illustrating a comparative example.

### DETAILED DESCRIPTION

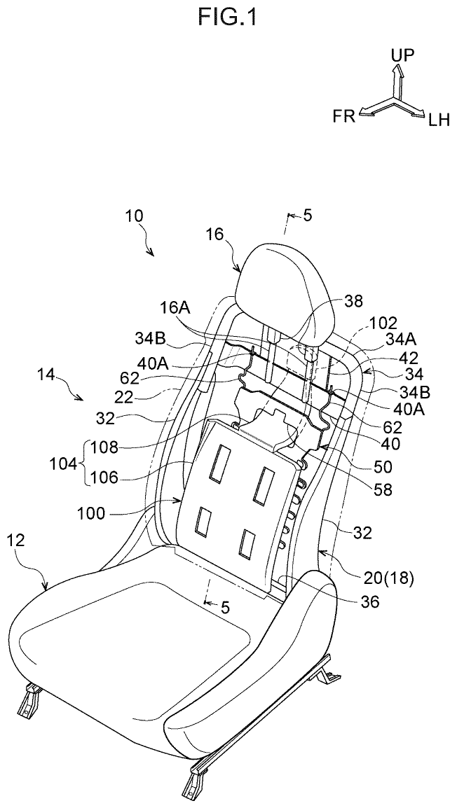

Hereinafter, a vehicle seat 10 according to an embodiment of the present disclosure will be described with reference to FIGS. 1 to 7. An arrow FR, an arrow UP, an arrow LH, and an arrow RH appropriately illustrated in each drawing indicate a seat front side, a seat upper side, a left side in a seat width direction, and a right side in the seat width direction of the vehicle seat 10. In the following description, when front-back, up-down, and left-right directions are used without any particular description, front-back, up-down, and left-right directions respectively indicate front-back in a seat front-rear direction (seat back thickness direction), up-down in a seat up-down direction (seat back up-down direction), and left-right in a seat left-right direction (seat back left-right direction).

[Overall Configuration of Vehicle Seat 10]

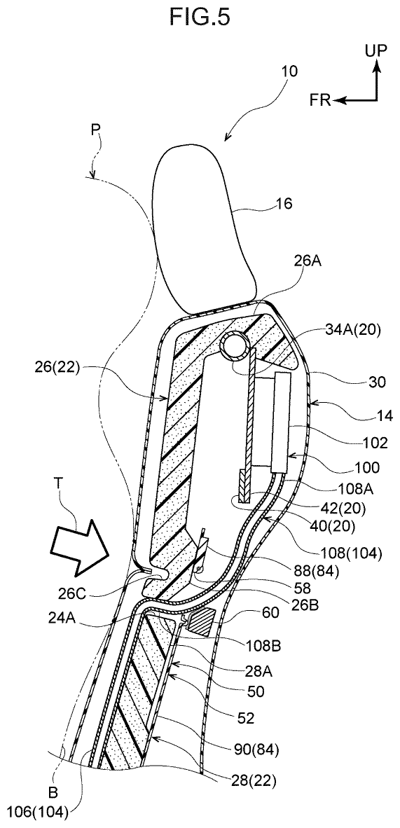

A vehicle seat 10 illustrated in FIG. 1 includes a seat cushion 12 configured to be able to support a hip and a thigh of an occupant P (see FIG. 5) as a seated person, and a seat back 14 connected to a rear end portion of the seat cushion 12 and configured to be able to support a back B (see FIG. 5) of the occupant P. The vehicle seat 10 further includes a headrest 16 connected to an upper end portion of the seat back 14 and configured to support a head of the occupant P.

The vehicle seat 10 includes a seat frame 18 that is a frame member made of metal, for example. The seat frame 18 includes a seat cushion frame (not illustrated) constituting a frame of the seat cushion 12 and a seat back frame 20 constituting a frame of the seat back 14. The seat back frame 20 is rotatably attached to a rear portion of a seat cushion frame (not illustrated) via a recliner (not illustrated). In FIG. 1, the seat back 14 is in a standing posture, and a thickness direction and a vertical direction of the seat back 14 substantially coincide with the front-rear direction and the vertical direction of the vehicle seat 10.

The seat back 14 includes a back support device 50 configured to assist a seated posture of the occupant P (see FIG. 5), and an air conditioning device 100 that sucks air from the back B (see FIG. 5) side of the occupant P, that is, a front side of the seat back 14 on which the occupant P is seated. The back support device 50 and the air conditioning device 100 will be described in detail later.

(Seat Back Pad 22)

The seat back frame 20 of the seat back 14 is provided with an elastic seat back pad 22 formed of foam such as urethane foam.

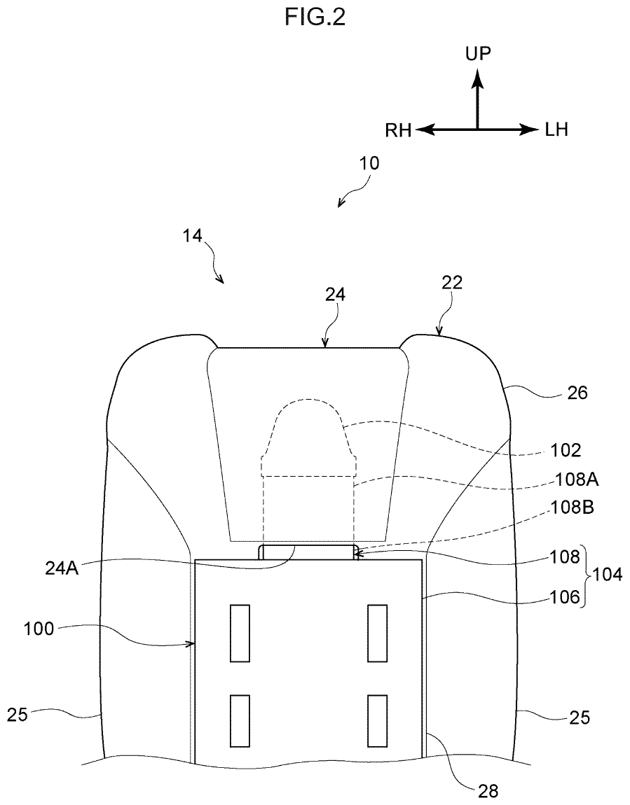

FIG. 2 is a front view of the seat back pad 22 and the air conditioning device 100. As illustrated in FIG. 2, the seat back pad 22 includes a main portion 24 disposed to face the back B (see FIG. 5) of the occupant P substantially in the front-rear direction, that is, in the thickness direction of the seat back 14, and a pair of left and right side support portions 25 provided on the left and right sides of the main portion 24 and formed to protrude forward from the main portion 24. In the main portion 24, a long hole 24A as an insertion portion is formed to penetrate in the thickness direction of the seat back 14. For example, the long hole 24A is formed at a position corresponding to a shoulder blade of the occupant P (see FIG. 5). The long hole 24A is formed in a substantially rectangular shape when viewed from the thickness direction of the seat back 14 so that a duct portion 108 of the air conditioning device 100 described later can be inserted therethrough. The position and shape of the long hole 24A are not limited to the above. The insertion portion need not be a long hole, and may have, for example, a circular shape or a square shape according to the shape of the duct portion.

The main portion 24 includes an upper pad 26 formed above the long hole 24A, that is, at a position corresponding to the shoulder or the neck of the occupant P (see FIG. 5) as an example, and a lower pad 28 formed below the long hole 24A, that is, at a position corresponding to the back B below the shoulder blade of the occupant P as an example. As an example, the upper pad 26 and the lower pad 28 are integrally molded. The upper pad 26 and the lower pad 28 will be described in detail later.

(Skin 30)

As illustrated in FIG. 5, the seat back pad 22 is covered with a skin 30 formed by sewing a plurality of skin pieces made of a cloth material, a knit material, synthetic leather, leather, or the like. The skin 30 is provided with a plurality of small openings (not illustrated) through which air flows from the occupant P side to a flow path forming portion 104 of the air conditioning device 100 to be described later. In FIG. 1, in order to clearly illustrate the internal structure of the seat back 14, the seat back pad 22 attached to the seat back frame 20 is illustrated by a virtual line, and the skin 30 is not illustrated.

(Seat Back Frame 20)

As illustrated in FIG. 1, the seat back frame 20 includes a pair of left and right side frames 32 extending substantially vertically at both end portions in the seat width direction. The seat back frame 20 further includes an upper frame 34 that couples upper end portions of the pair of left and right side frames 32 in the seat width direction, and a lower frame 36 that couples lower end portions of the pair of left and right side frames 32 in the seat width direction.

The upper frame 34 is formed in a substantially U shape whose lower side is opened when viewed from the thickness direction of the seat back 14. Specifically, the upper frame 34 includes an upper pipe 34A extending in the seat width direction, and a pair of left and right upper side pipes 34B formed integrally downward from both end portions of the upper pipe 34A in the seat width direction. Lower portions of the pair of left and right upper side pipes 34B are fixed to upper end portions of the pair of left and right side frames 32, respectively.

A pair of left and right stay support portions 38 extending substantially in the vertical direction is fixed to the front side of the upper pipe 34A in the upper frame 34. Each of the pair of left and right stay support portions 38 is formed in a tubular shape, and a pair of left and right headrest stays 16A of the headrest 16 is inserted therethrough.

A plate-shaped bridge frame 40 extending in the seat width direction with the thickness direction of the seat back 14 as the thickness direction is provided below the upper pipe 34A. Both end portions in the seat width direction of the bridge frame 40 are fixed to the rear sides of the pair of left and right upper side pipes 34B.

A blower base 42 for fixing a blower 102 of the air conditioning device 100 described later is provided between the upper pipe 34A and the bridge frame 40 when viewed from the thickness direction of the seat back 14. An upper end portion of the blower base 42 is fixed to a rear side of a central portion of the upper pipe 34A in the seat width direction. Meanwhile, a lower end portion of the blower base 42 is fixed to the rear side of the central portion in the seat width direction of the bridge frame 40.

A pair of left and right upper support portions 40A formed in a substantially cylindrical shape is provided at an upper end portion of the bridge frame 40. A support wire 62 of the back support device 50 to be described later is inserted and fitted into the upper support portion 40A. As described above, the upper end portion of the back support device 50 is connected to the bridge frame 40 to be supported by the seat back frame 20.

Meanwhile, the lower end portion of the back support device 50 is connected to the lower frame 36 to be supported by the seat back frame 20. The configuration of the seat back frame 20 is not limited to the above.

[Air Conditioning Device 100]

Next, the air conditioning device 100 incorporated in the seat back 14 will be described.

The air conditioning device 100 includes the blower 102 as an air conditioner, and the flow path forming portion 104 that is connected to the blower 102 and forms a flow path through which air sucked from a seating surface side of the seat back 14, that is, the back B (see FIG. 5) side of the occupant P flows to the blower 102.

(Blower 102)

The blower 102 is attached to the rear side of the blower base 42 on the seat upper side and the seat rear side of the back support device 50. The blower 102 sucks air from the flow path forming portion 104 and blows out the air from a blow-out port (not illustrated).

(Flow Path Forming Portion 104)

The flow path forming portion 104 is formed of a soft material such as a polyurethane film. The flow path forming portion 104 includes a ventilation portion 106 that sucks air from the seating surface side of the seat back 14, and a duct portion 108 that connects the blower 102 and the ventilation portion 106. The material of the flow path forming portion 104 is not limited to the above.

As illustrated in FIG. 2, the ventilation portion 106 is formed in a substantially rectangular shape whose vertical direction is a longitudinal direction when viewed from the thickness direction of the seat back 14, and is disposed on a front surface side of the main portion 24 in the seat back pad 22. The ventilation portion 106 is provided along the central portion of the back B of the occupant P (see FIG. 5) in the main portion 24 over substantially the entire lower pad 28 in the seat width direction and the seat vertical direction.

A plurality of ventilation ports (not illustrated) is formed on the front side of the ventilation portion 106. Air is sucked into the ventilation portion 106 from the seating surface side of the seat back 14 through the ventilation port, and the air sucked through the duct portion 108 is sent to the blower 102.

The duct portion 108 is formed in a substantially rectangular cylindrical shape in a planar cross-sectional view and in a substantially rectangular shape whose vertical direction in the longitudinal direction when viewed from the thickness direction of the seat back 14. An upper end portion 108A of the duct portion 108 is connected to the blower 102. Meanwhile, a lower end portion 108B of the duct portion 108 is connected to a central portion of an upper end portion of the ventilation portion 106 in the seat width direction. As a result, the duct portion 108 is disposed in a substantially J shape in a side view as viewed from the left side in the seat width direction (see FIGS. 1 and 5).

The lower end portion 108B of the duct portion 108 is inserted through the long hole 24A of the seat back pad 22 and is disposed substantially in the front-rear direction. As illustrated in FIG. 5, a lower end portion 108B of the duct portion 108 is inserted into an opening portion 58 formed in a basket 52 of the back support device 50 described later. That is, the duct portion 108 extending from the ventilation portion 106 passes through the long hole 24A of the seat back pad 22, further passes through the opening portion 58 of the back support device 50, and is connected to the blower 102.

[Back Support Device 50]

Next, the back support device 50 will be described in detail. The back support device 50 is built in the seat back 14 on the seat rear side of the seat back pad 22.

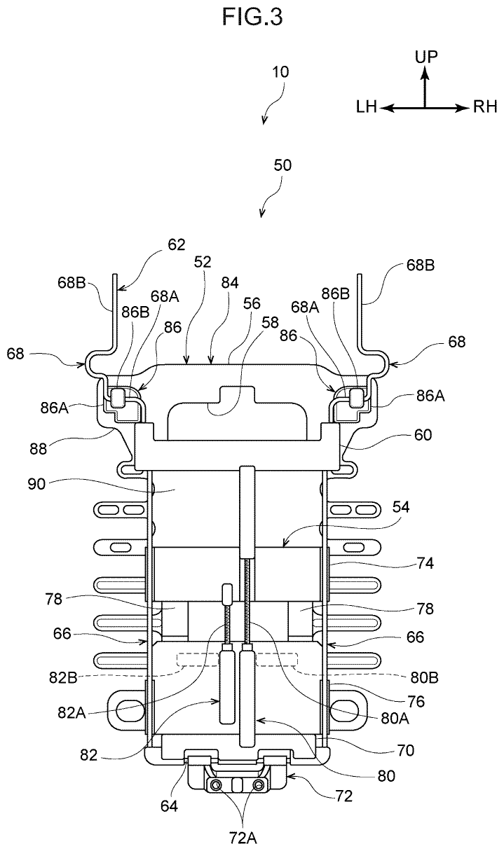

FIG. 3 illustrates a rear view of the back support device 50. The back support device 50 includes a basket 52 as a pressure receiving portion configured to be deformable by receiving a load from the back B of the occupant P (see FIG. 5), and a lumbar support portion 54 configured to be able to support the waist including a lumbar of the occupant P via the basket 52.

In an upper portion 56 of the basket 52, an opening portion 58 penetrating substantially in the front-rear direction, that is, in the thickness direction of the seat back 14 (see FIG. 1) is formed. The back support device 50 includes an upper frame portion 60 that extends in the seat width direction and supports the basket 52 from the rear side. That is, the basket 52 is supported from the seat rear side by the upper frame portion 60 and the lumbar support portion 54.

In addition, the back support device 50 includes the support wire 62 formed in a substantially U shape with an upper side opened when viewed from the thickness direction of the seat back 14. The support wire 62 includes a lower wire 64 extending in the seat width direction at the lower end portion, and a pair of left and right guide wires 66 extending upward from both end portions of the lower wire 64 in the seat width direction.

Upper end portions 68 of the pair of left and right guide wires 66 include a locked portion 68A extending in the seat width direction and a supported portion 68B extending substantially upward from an outer end portion of the locked portion 68A in the seat width direction. The locked portion 68A is locked to a locking portion 86 of the basket 52 described later. The supported portion 68B is inserted into and fitted to the upper support portion 40A (see FIG. 1) of the bridge frame 40.

Both end portions of the upper frame portion 60 in the seat width direction are fixed to upper portions of the pair of left and right guide wires 66 on the lower side of the locked portion 68A.

The back support device 50 includes a lower frame portion 70 connected to the lower wire 64 and extending in the seat width direction. A coupling portion 72 is connected to a central portion of the lower wire 64 in the seat width direction. The coupling portion 72 is formed with a pair of left and right lower support holes 72A. The coupling portion 72 is fastened to the lower frame 36 of the seat back frame 20 (see FIG. 1) by bolts (not illustrated) inserted into the lower support holes 72A.

(Lumbar Support Portion 54)

The lumbar support portion 54 includes an upper lifting/lowering portion 74 provided in an upper portion and a lower lifting/lowering portion 76 provided in a lower portion. The upper lifting/lowering portion 74 and the lower lifting/lowering portion 76 are slidably engaged with the pair of left and right guide wires 66 at both end portions in the seat width direction. The upper lifting/lowering portion 74 and the lower lifting/lowering portion 76 are connected in a substantially vertical direction by a pair of left and right arch forming portions 78. The arch forming portion 78 is made of, for example, a metal plate or a resin plate having belt-like elasticity with the vertical direction as a longitudinal direction.

The lumbar support portion 54 further includes a support portion lifting/lowering mechanism 80 provided on a right side and an arch deformation mechanism 82 provided on a left side at a central portion in the seat width direction.

The support portion lifting/lowering mechanism 80 includes a screw shaft 80A extending in the vertical direction, a motor 80B provided in the lower lifting/lowering portion 76, and a gear mechanism (not illustrated) that connects the motor 80B and the screw shaft 80A. The screw shaft 80A is screwed to a nut (not illustrated) provided in the lower lifting/lowering portion 76. In the screw shaft 80A, an upper end portion is fixed to the upper frame portion 60 and a lower end portion is fixed to the lower frame portion 70. The support portion lifting/lowering mechanism 80 is a feed screw mechanism that moves the upper lifting/lowering portion 74 and the lower lifting/lowering portion 76 up and down integrally by driving the motor 80B.

Meanwhile, the arch deformation mechanism 82 includes a screw shaft 82A extending in the vertical direction, a motor 82B provided in the lower lifting/lowering portion 76, and a gear mechanism (not illustrated) that connects the motor 82B and the screw shaft 82A. The screw shaft 82A is screwed to a nut (not illustrated) provided in the lower lifting/lowering portion 76. In the screw shaft 82A, an upper end portion is fixed to the upper lifting/lowering portion 74 and a lower end portion is fixed to the lower lifting/lowering portion 76. The arch deformation mechanism 82 is a feed screw mechanism that moves the upper lifting/lowering portion 74 in the vertical direction with respect to the lower lifting/lowering portion 76 by driving the motor 82B. The arch deformation mechanism 82 is configured to deform the arch forming portion 78 by changing an interval between the upper lifting/lowering portion 74 and the lower lifting/lowering portion 76 as described above. That is, the lumbar support portion 54 is configured such that the support position can be adjusted up and down by the support portion lifting/lowering mechanism 80 while adjusting the strength of support for the waist of the occupant P (see FIG. 5) by deforming the arch forming portion 78 by the arch deformation mechanism 82.

(Basket 52)

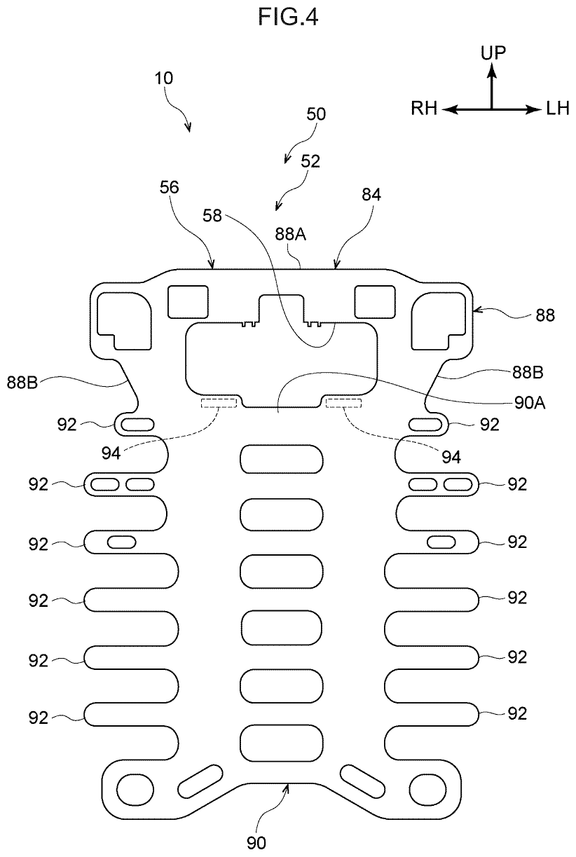

The basket 52 of the back support device 50 is formed of, for example, a resin material, and includes a plate-shaped basket main body 84 formed integrally. FIG. 4 illustrates a front view of the basket main body 84.

As illustrated in FIG. 4, the opening portion 58 penetrating in the plate thickness direction is formed in an upper portion of the basket main body 84 and at a central portion in the seat width direction. The opening portion 58 is formed in a substantially rectangular shape whose seat width direction is the longitudinal direction when viewed from the substantially front-rear direction.

As illustrated in FIG. 5, the duct portion 108 of the air conditioning device 100 is inserted through the opening portion 58 formed in the basket main body 84. When viewed from the seat front surface side in the thickness direction of the seat back 14, the opening portion 58 of the back support device 50 is disposed on the back side of the long hole 24A in the seat back pad 22, more specifically, in the vicinity of the long hole 24A and slightly above the long hole 24A of the seat back pad 22.

As illustrated in FIG. 4, the basket main body 84 includes an upper end portion 88 in which a pair of left and right locking portions 86 (see FIG. 3) is provided on the rear side, a central lower portion 90 formed at a central portion in the seat width direction from a substantially central portion to a lower end portion in the vertical direction, and a plurality of pairs of left and right side portions 92 extending in the left-right direction from both end portions in the seat width direction of the central lower portion 90.

Since the opening portion 58 is formed, the upper end portion 88 of the basket main body 84 is formed in a substantially U shape whose lower side is opened when viewed from the substantially front-rear direction. Specifically, the upper end portion 88 includes an upper portion 88A extending in the seat width direction and a pair of left and right side portions 88B extending downward from both end portions of the upper portion 88A in the seat width direction. The lower end portions of the pair of left and right side portions 88B are integrally connected to the left and right end portions of an upper end portion 90A of the central lower portion 90 of the basket main body 84 and the upper end of the side portion 92 provided at the uppermost portion.

As illustrated in FIG. 3, the pair of left and right locking portions 86 is provided at both end portions in the seat width direction of the upper end portion 88 of the basket 52. Specifically, the pair of left and right locking portions 86 includes a base portion 86A provided on a surface on the seat rear side of the basket main body 84 and a hook 86B formed in a downward substantially L-shape in a side view. The hook 86B extends rearward and downward from the rear surface of the base portion 86A.

By hooking the pair of left and right hooks 86B on the locked portions 68A of the pair of left and right guide wires 66, the locking portion 86 of the basket 52 is locked to the locked portion 68A of the support wire 62.

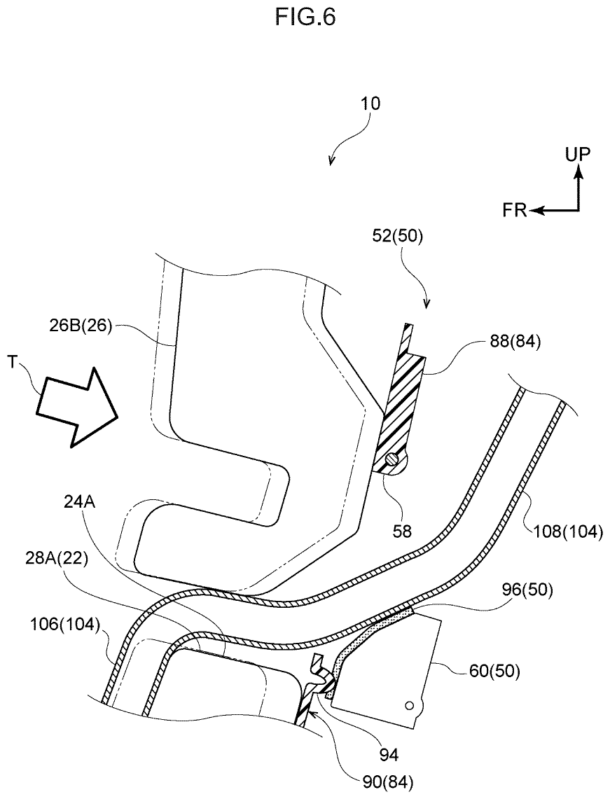

As illustrated in FIG. 6, on the seat rear side of the basket 52, a protrusion 94 protruding toward the seat rear side is formed at a position facing the upper frame portion 60. A pair of left and right protrusions 94 are formed on the lower edge portion of the opening portion 58, that is, on the rear side of the central portion in the seat width direction of the upper end portion 90A (see FIG. 4) of the central lower portion 90 of the basket main body 84, and extend in the seat width direction.

A felt 96 is attached to the seat front side of the upper frame portion 60. The felt 96 is formed in a substantially rectangular shape whose seat width direction is the longitudinal direction when viewed from the substantially front-rear direction. The duct portion 108 (see FIG. 1) of the air conditioning device 100 is disposed through the upper side of the felt 96.

The basket 52 is supported by the upper frame portion 60 from the seat rear side at the lower edge portion of the opening portion 58, that is, at the central portion in the seat width direction of the upper end portion 90A (see FIG. 4) of the central lower portion 90 of the basket main body 84 in a state where the protrusion 94 abuts on the felt 96. The central lower portion 90 of the basket main body 84 is configured to be deformable with the protrusion 94 provided on the upper end portion 90A as a fulcrum. The configuration of the back support device 50 is not limited to the above.

[Regarding Positional Relationship of Each Configuration]

As illustrated in FIG. 5, in the upper pad 26 formed on the upper side of the long hole 24A in the main portion 24 of the seat back pad 22, an upper end portion 26A extends rearward in a cross-sectional view viewed from the seat side. The seat back pad 22 is attached to the seat back frame 20 by at least the upper end portion 26A of the upper pad 26 being hooked on the upper pipe 34A. A lower end portion 26B of the upper pad 26 has a recessed groove 26C on the front side. The skin 30 is drawn into and fixed to the recessed groove 26C formed in the upper pad 26.

Meanwhile, the lower pad 28 formed on the seat back pad 22 below the long hole 24A is provided on the front side of the central lower portion 90 and the side portion 92 (see FIG. 4) of the basket 52 supported by the upper frame portion 60. In other words, the lower pad 28 is supported from the rear side by the central lower portion 90 and the side portion 92 (see FIG. 4) of the basket 52.

In the air conditioning device 100, the flow path forming portion 104 connected to the blower 102 is inserted into the opening portion 58 of the back support device 50 through the rear side of the upper pad 26, and further extends to the front side of the lower pad 28 through the long hole 24A formed between the upper pad 26 and the lower pad 28.

Here, the lower end portion 26B of the upper pad 26 is formed to bulge rearward in a cross-sectional view as viewed from the seat side at substantially the same height as the upper end portion 88 of the basket main body 84 of the back support device 50. Specifically, the lower end portion 26B of the upper pad 26 is configured to abut on the upper edge portion of the opening portion 58, that is, the lower end portion of the upper end portion 88 of the basket main body 84 when a load is applied substantially rearward (direction of arrow T in FIG. 5) from the back B of the occupant P with respect to the seat back 14 and to be restricted from moving rearward.

The lower end portion 26B of the upper pad 26 is provided above the central lower portion 90 of the basket main body 84. That is, the lower end portion 26B of the upper pad 26 is configured such that the duct portion 108 is not sandwiched between the lower end portion 26B of the upper pad 26 and the upper end portion 90A (see FIG. 4) of the central lower portion 90 in the basket main body 84 of the back support device 50 even when a load is applied to the seat back 14 substantially rearward (direction of arrow T in FIG. 5) from the back B of the occupant P. The lower end portion 26B of the upper pad 26 is configured such that the duct portion 108 is not sandwiched between the lower end portion 26B of the upper pad 26 and the upper frame portion 60 of the back support device 50 even when a load is applied to the seat back 14 substantially rearward (direction of arrow T in FIG. 5) from the back B of the occupant P.

The upper end portion 28A of the lower pad 28 is provided below the upper end portion 88 of the basket main body 84. That is, the upper end portion 28A of the lower pad 28 is configured such that the duct portion 108 is not sandwiched between the upper end portion 28A of the lower pad 28 and the back support device 50 even when a load is applied to the seat back 14 substantially rearward (direction of arrow T in FIG. 5) from the back B of the occupant P.

### Operation of Present Embodiment

Next, the operation of the present embodiment will be described.

According to the vehicle seat 10 of the present embodiment, the back B of the occupant P is supported by the back support device 50 and the seat back pad 22 supported by the back support device 50 from the rear side. Air is sucked into the blower 102 from the vicinity of the back B of the occupant P via the flow path forming portion 104.

The seat back pad 22 is restricted from moving toward the seat rear side by the back support device 50 provided on the seat rear side of the seat back pad 22. Here, the flow path forming portion 104 connected to the blower 102 is inserted into the opening portion 58 penetrating in the thickness direction of the seat back 14 in the back support device 50. Therefore, it is possible to prevent the flow path forming portion 104 from being pinched and crushed between the seat back pad 22 and the end portion in the seat vertical direction or the end portion in the seat width direction of the back support device 50. As a result, the flow of air sucked from the occupant P side and sent to the blower 102 through the flow path forming portion 104 is prevented from being obstructed. Therefore, the air-conditioning efficiency of the air conditioning device 100 can be improved.

Since the blower 102 is provided on the seat upper side of the back support device 50, that is, at a position not overlapping with the back support device 50 when viewed from the thickness direction of the seat back 14, the dimension of the seat back 14 in the thickness direction can be suppressed.

The flow path forming portion 104 extending from the blower 102 is disposed through the rear side and the upper side of the opening portion 58 of the back support device 50. Even in a case in which the blower 102 is not disposed immediately behind the opening portion 58 as described above, the back support device 50 restricts the movement of the seat back pad 22 toward the seat rear side, so that deformation of the flow path forming portion 104 passing through the rear side of the back support device 50 is suppressed. Therefore, it is possible to prevent the flow path forming portion 104 extending from the blower 102 from being sandwiched and crushed between the seat back pad 22 and the upper end portion 88 of the back support device 50. Therefore, the design of the vehicle seat 10 can be improved while maintaining the performance of the back support device 50 and the air conditioning device 100.

The waist of the occupant P is supported by the lumbar support portion 54 via the basket 52. Since the basket 52 is deformed by receiving a load from the back B of the occupant P, the occupant P can maintain a favorable seated posture.

Here, as illustrated in FIG. 6, the upper portion 56 of the basket 52 is supported by the upper frame portion 60. Specifically, the basket 52 is supported from the seat rear side by the upper frame portion 60 at the lower edge portion of the opening portion 58, that is, at the central portion in the seat width direction in the upper end portion 90A (see FIG. 4) of the central lower portion 90 of the basket main body 84.

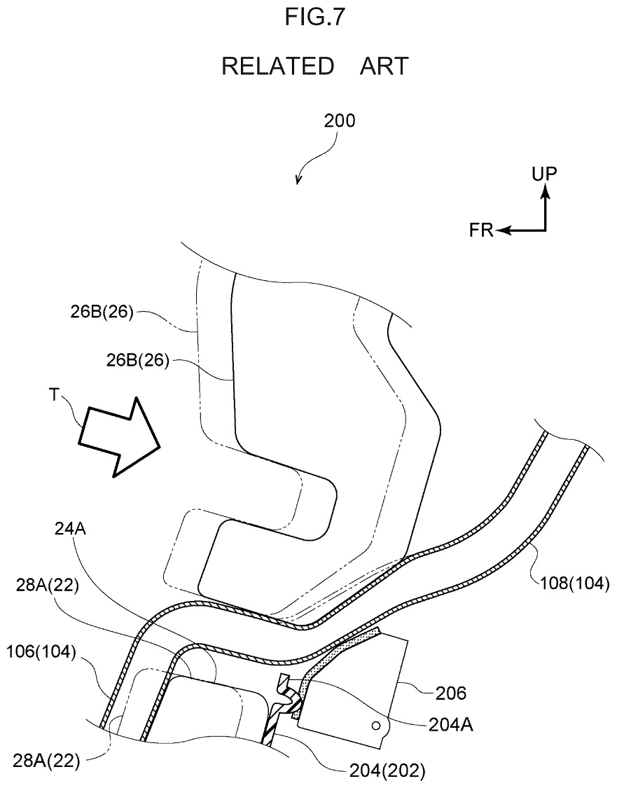

FIG. 7 illustrates, as a comparative example, a vehicle seat 200 provided with a back support device 202 in which no opening portion is formed in the basket 204. The same components as those of the present embodiment are denoted by the same reference numerals, and the description thereof will be appropriately omitted.

As illustrated in FIG. 7, in a case in which no opening portion is formed in the basket 204 of the back support device 202, the flow path forming portion 104 will be connected to the blower 102 (see FIG. 5) through the upper side of the back support device 202. In this case, when a load is applied to the seat back 14 substantially rearward (direction of arrow T in FIG. 5) from the back B of the occupant P, the flow path forming portion 104 is sandwiched and crushed between an upper end portion 204A of the basket 204 or an upper frame portion 206 and the upper pad 26 of the seat back pad 22.

Meanwhile, with the vehicle seat 10 according to the present embodiment, as illustrated in FIG. 6, the upper edge portion of the opening portion 58 formed in the upper portion 56 of the basket 52 of the back support device 50, that is, the lower end portion of the upper end portion 88 of the basket main body 84 restricts the movement of the upper pad 26 toward the seat rear side. This prevents the flow path forming portion 104 from being sandwiched between the upper pad 26 and the lower edge portion of the opening portion 58, that is, the central portion in the seat width direction of the upper end portion 90A (see FIG. 4) of the central lower portion 90 of the basket main body 84. The flow path forming portion 104 is prevented from being sandwiched between the upper pad 26 and the upper frame portion 60.

As illustrated in FIGS. 2 and 5, the ventilation portion 106 connected to the duct portion 108 extends along the front surface side of the lower pad 28 in the main portion 24 of the seat back pad 22, and air is sucked from the periphery of the back B of the occupant P by the ventilation portion 106. Therefore, the periphery of the back B of the occupant P is efficiently ventilated.

As illustrated in FIG. 6, since the opening portion 58 of the back support device 50 is formed in the vicinity of the long hole 24A of the seat back pad 22, the duct portion 108 is prevented from being sandwiched and crushed between the basket 52 and the seat back pad 22 in a section between the opening portion 58 of the back support device 50 and the long hole 24A of the seat back pad 22. Since the duct portion 108 does not need to be disposed in a long bent complicated path, the air-conditioning efficiency can be further improved while the duct portion 108 is disposed in the seat back 14 with high space efficiency.

The opening portion 58 of the back support device 50 is disposed in the vicinity of the long hole 24A of the seat back pad 22 when viewed from the thickness direction of the seat back 14, and is disposed slightly above the long hole 24A of the seat back pad 22. As a result, the flow path forming portion 104 is efficiently arranged from the blower 102 provided in the upper portion of the seat back 14 to the front surface side of the lower pad 28 provided in the lower portion of the seat back 14.

### SUPPLEMENTARY DESCRIPTION OF EMBODIMENT

In the above embodiment, the air conditioning device 100 sucks air from the occupant P side of the seat back 14, but the present invention is not limited thereto, and the air conditioning device 100 may be a device that blows air toward the occupant P side of the seat back 14.

In the embodiment described above, the blower 102 is provided above the seat with respect to the back support device 50, but the present invention is not limited thereto, and the back support device 50 may be provided at another position in the seat back 14.

In the above embodiment, the upper frame portion 60 of the back support device 50 has been described to support the basket 52 from the seat rear side by the protrusion 94 provided at the lower edge portion of the opening portion 58, that is, at the central portion in the seat width direction of the upper end portion 90A of the central lower portion 90 of the basket main body 84, but the present invention is not limited thereto. For example, the upper frame portion 60 may support the basket 52 at a side portion 88B of the upper end portion 88 illustrated in FIG. 4.

In the seat back pad 22, the upper pad 26 and the lower pad 28 are integrally formed, and the long hole 24A is formed. However, the present invention is not limited to this. For example, the upper pad 26 and the lower pad 28 may be formed separately, and an insertion portion penetrating in the thickness direction of the seat back 14 may be provided between the upper pad 26 and the lower pad 28. As still another example, the flow path forming portion 104 may extend from the rear side of the seat back pad 22 to the intermediate portion of the seat back pad 22 in the thickness direction, that is, is not necessarily extend to the front side of the seat back pad 22. That is, the long hole 24A may not be formed in the seat back pad 22, and air may be sucked from the periphery of the back B of the occupant P through a small opening formed in the seat back pad 22, and ventilation may be performed through the flow path forming portion 104 extending from the rear side of the seat back pad 22 to the intermediate portion of the seat back pad 22 in the thickness direction.

What is claimed is:

1. A vehicle seat, comprising:
a seat back pad attached to a seat back frame configuring a frame;
a back support device provided on a seat rear side of the seat back pad, configured to assist a seated posture of a seated person, and including an opening penetrating in a seat back thickness direction; and
an air conditioning device including an air conditioner configured to suction and blow out air, and a flow path forming portion connected to the air conditioner, inserted into the opening of the back support device, and performing at least one of blowing out air to a side of the seated person or suctioning air from the seated person side in accordance with the air conditioner.

2. The vehicle seat according to claim 1, wherein the air conditioner of the air conditioning device is provided above the back support device in the seat.

3. The vehicle seat according to claim 2, wherein the back support device includes:
a pressure receiving portion which is configured to be deformable by receiving a load from a back of the seated person and in which the opening is formed at an upper portion,
a lumbar support portion configured to support a waist of the seated person via the pressure receiving portion, and
an upper frame portion configured to support the upper portion of the pressure receiving portion from the seat rear side at a lower edge portion of the opening portion.

4. The vehicle seat according to claim 3, wherein the seat back pad includes an insertion portion penetrating in the seat back thickness direction, and
the flow path forming portion includes a duct portion connected to the air conditioner and inserted into the opening of the back support device and the insertion portion of the seat back pad, and a ventilation portion connected to the duct portion and extending along a front surface side of the seat back pad, the ventilation portion performing at least one of the blowing out of air to the seated person side and the suctioning of air from the seated person side in accordance with the air conditioner.

5. The vehicle seat according to claim 4, wherein the opening of the pressure receiving portion in the back support device is formed at a back side of the insertion portion of the seat back pad as viewed from a seat front surface side in the seat back thickness direction.
